(19) United States
(12) Patent Application Publication
(10) Pub. No.: US 2009/0008518 A1
(43) Pub. Date: Jan. 8, 2009

(54) MONITOR WITH ADJUSTABLE SCREEN IN HIGHNESS AND INCLINATION

(76) Inventor: Hszu-Mei Shen, Suzhou City (CN)

Correspondence Address: G. LINK CO., LTD., 3550 BELL ROAD, MINOOKA, IL, 60447, US

(21) Appl. No.: 11/773,404

(22) Filed: Jul. 4, 2007

(51) Int. Cl. A47F 5/00; G06F 1/16

(52) U.S. Cl. 248/122.1; 361/681

(57) ABSTRACT

A monitor with a screen adjustable in highness and inclination provides a H-shaped adjusting member with a first end, a second end, a third end and a fourth end to connect with shafts attached to support arms extending from the base in association with an actuation part to allow the adjusting member capable of rotating on the base. Further, the adjusting member is rotationally connected to a main monitor member with another shaft and another actuation part. Besides, two four-bar linkages each provide a fixing end to connect with two of the shafts on the support arms and a movable end to connect with the other two of the shafts on the support arms for obtaining strong structure of the monitor and adjusting highness and inclination of the screen conveniently.

### BACKGROUND OF THE INVENTION

1. Field of the Invention

The present invention is related to a monitor and particularly to a monitor capable of adjusting highness and inclination of the display screen thereof.

2. Brief Description of the Related Art

Due to information technology being developed progressively, the monitor with screen display is widely applied for showing pictures such as graphical images. The traditional cathode ray tub (CRT), which has been popularly used for a long time, has been replaced with the liquid crystal display (LCD) gradually, which is light and thin in size.

In order to meet the user's need and comfort, the monitor has to be equipped an adjustment device for the screen of the monitor being possible to change highness and inclination according to visual line of the user. However, the conventional adjustment device provides either insufficient structural strength or operational inconvenience such that how to develop an adjustment device with strong structure and easy operation is a subject cared by the users.

### SUMMARY OF THE INVENTION

Accordingly, an object of the present invention is to provide a monitor with a screen adjustable in highness and inclination, which is strong in structure and easy for operation.

In order to achieve the preceding object, a monitor with a screen adjustable in highness and inclination according to the present invention includes a main monitor member, a base, an adjusting member, a first actuation part, a first shaft, a second actuation part, a second shaft, a third actuation part, a third shaft, a fourth actuation part, a fourth shaft, a first four-bar linkage and a second four-bar linkage.

Wherein the base provides a bottom disk and extending upward a first support arm, a second support arm, a third support arm and a fourth support arm from the bottom disk; the first shaft is connected to the first support arm and the second support arm and the second shaft is connected to the third support arm and the fourth support arm; the adjusting member provides a shape of “H” with a first end, a second end, a third end and a fourth end, the first end being actuated by the first actuation part and being rotationally connected to the first shaft, the second end being actuated by the second actuation part and being rotationally connected to the second shaft, the third end being actuated by the third actuation part and being rotationally connected to the third shaft, and the fourth end being actuated by the forth actuation part and being rotationally connected to the fourth shaft.

Further, the first four-bar linkage provides a first fixing end being connected to the first shaft and a first movable end being connected to the third shaft; the second four-bar linkage provides a second fixing end being connected to the second shaft and a second movable end being connected to the fourth shaft; and the main monitor member provides a display screen and is actuated by the third actuation part to rotationally connect with the third shaft and actuated by the fourth actuation part to rotationally connect with the fourth shaft.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a preferred embodiment of a monitor with a screen adjustable in highness and inclination according to the present invention illustrating the rear side thereof;

FIG. 2 is a perspective view similar to FIG. 1 illustrating the decoration casing being removed;

FIG. 3 is a perspective view of FIG. 2 illustrating the screen shown in FIG. 2 being removed;

FIG. 4 is an exploded perspective view of FIG. 3;

FIG. 5 is an enlarged perspective view of portion 5 shown in FIG. 4;

FIG. 6 is an enlarged perspective view of portion 6 shown in FIG. 4;

FIG. 7 is an enlarged perspective view of portion 7 shown in FIG. 4; and

FIG. 8 is an enlarged perspective view of portion 8 shown in FIG. 4.

### DETAILED DESCRIPTION OF THE INVENTION

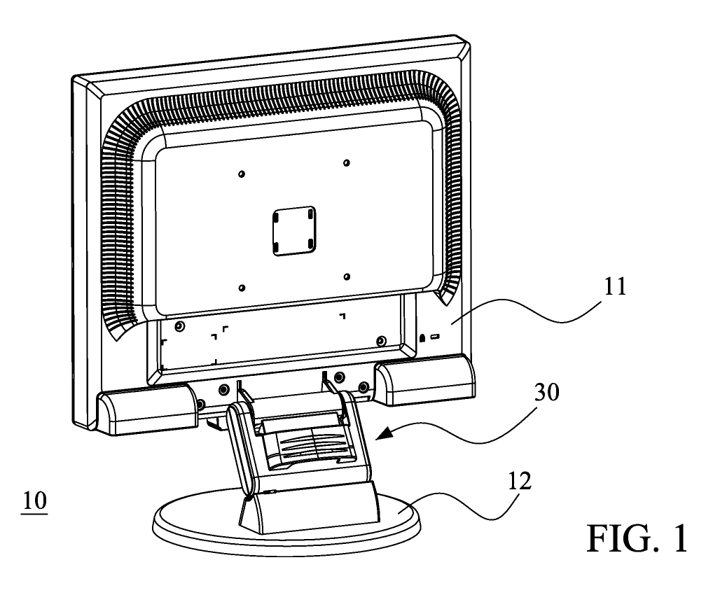

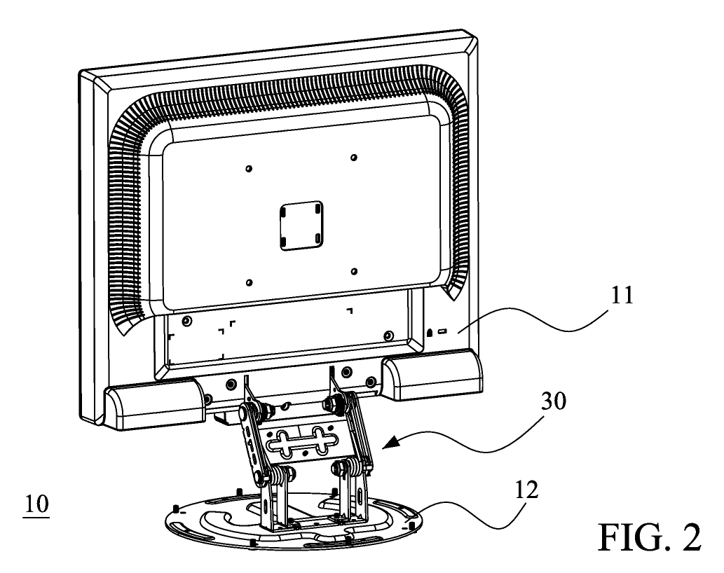

Referring to FIGS. 1 and 2, the preferred embodiment of a monitor with a screen adjustable in highness and inclination according to the present invention are illustrated. The monitor 10 includes a main monitor member 11, a base 12 and an adjustable device 30. The main monitor member 11 provides a screen and the adjustable device 30 is used for adjusting highness and inclination of the main monitor member 11 with respect to the bass 12. The mechanism of the adjustable device 30 in association with principle of movement thereof is recited in detail hereinafter.

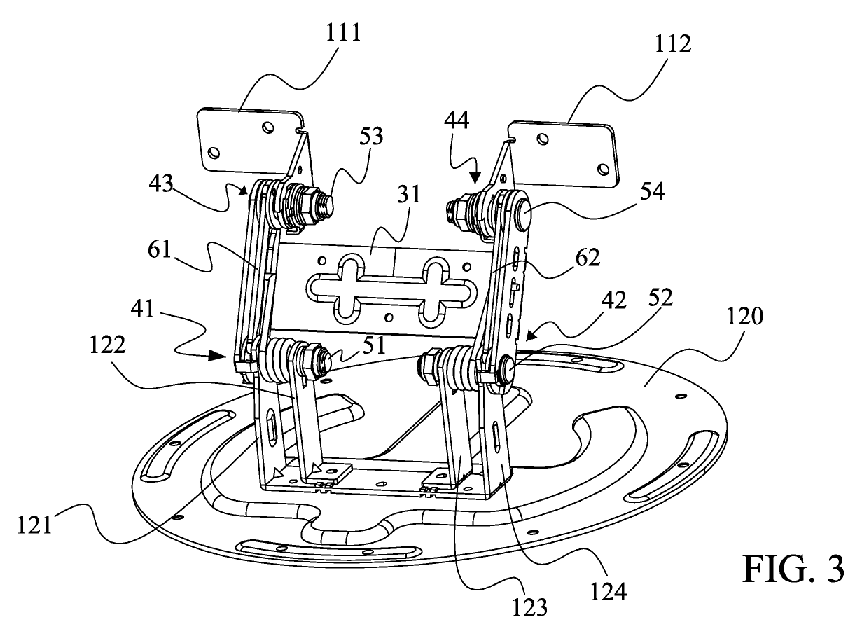

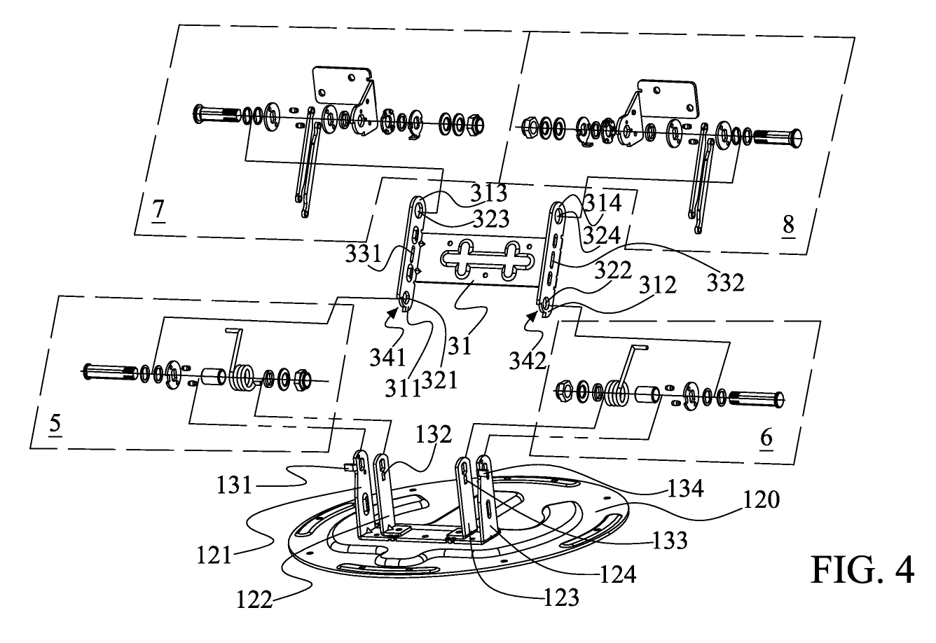

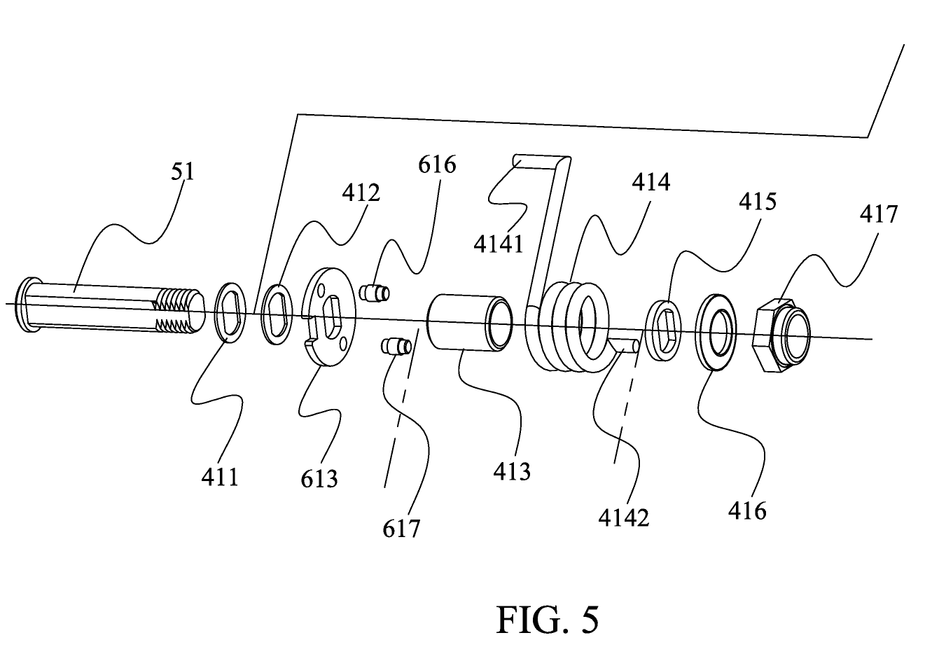

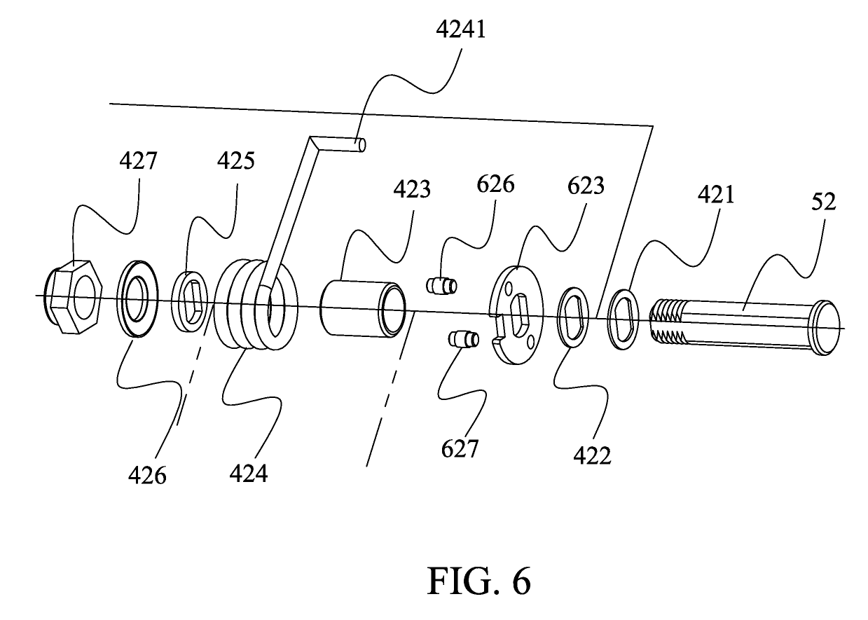

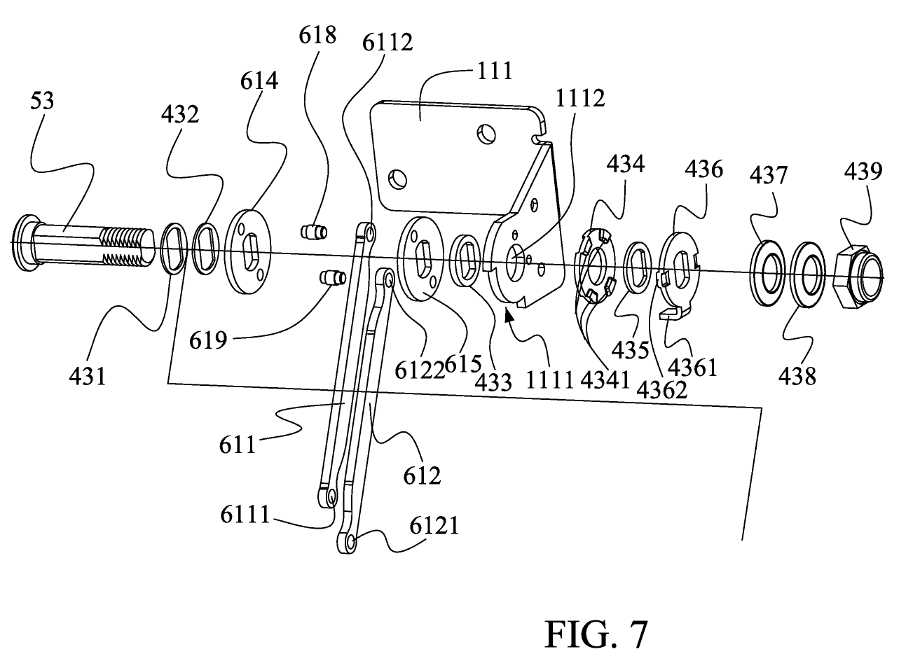

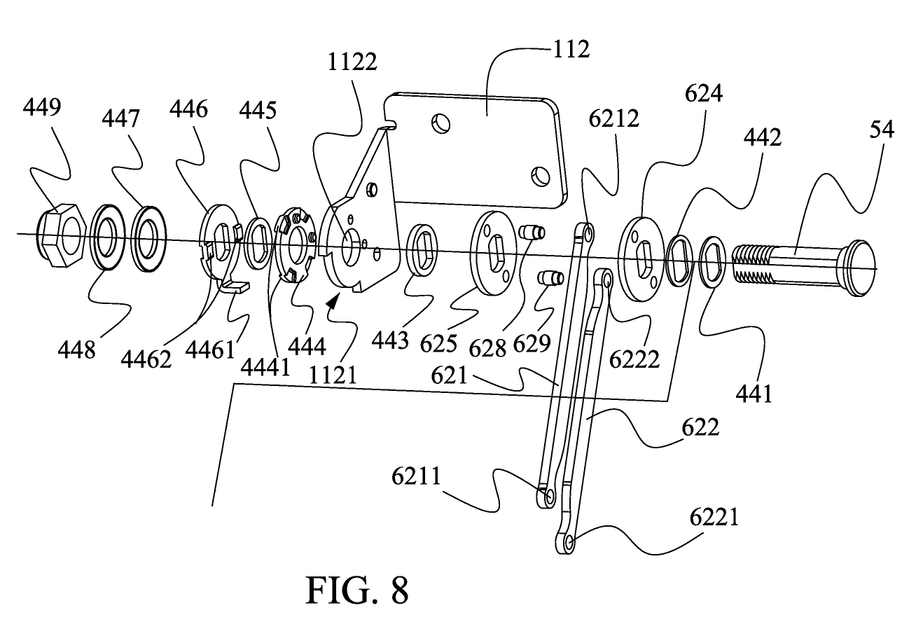

Referring to FIGS. 3 to 8, the base 12 has a bottom disk 120 and a first arm 121, a second support arm 122, a third support arm 123 and a fourth support arm 124 are joined to the base 12 and extend upward from the base 12. The first support arm 121 and the fourth support arm 124 each provide a locating tongue 131, 134 and the second support arm 122 and the third support arm 123 each provide a spring hole 132, 133. The adjustable device 30 further includes an adjusting member 31, actuation parts 41, 42, 43, 44, which offer the adjusting member 31 actuation forces to rotate with respect to the base 12, holding parts 111, 112 of the adjusting member 31, shafts 51, 52, 53, 54 and four-bar linkages 61, 62.

The adjusting member 31 provides an “H” shape with a first end 311, a second end 312, a third end 313 and a fourth end 314. A circular through hole 312, 322, 323, 324 is disposed at the first end 311, the second end 312, a third end 313 and the fourth end 314 respectively. A spring hole 331 is arranged between the first end 311 and the third end 313 and another spring hole 332 is arranged between the second end 312 and the fourth end 314. Further, the first end 311 and the second end 312 have a 60° arc recess 341, 342 respectively.

The actuation part 41 includes wearable pieces 411, 412, 415, a sleeve 413, a torsion spring 413, a disk washer 416 and a nut 417. The actuation part 42 includes wearable pieces 421, 422, 425, a sleeve 423, a torsion spring 424, a disk washer 426 and a nut 427. Further, the actuation part 43 includes wearable pieces 431, 432, 433, 435, a two-stage type elastic locating piece 434, a two-stage type hanging hook 436, disk washer 437, 438 and a nut 439. The actuation part 44 includes wearable pieces 441, 442, 443, 445, a two-stage type elastic locating piece 444, a two-stage type hanging hook 446, disk washer 447, 448 and a nut 449. Wherein the positions and numbers of the respective wearable piece and the respective disk washer depend on how much the rotary actuation force needed by the actuation respective part 41, 42, 43, 44 and how much force the adjusting device 30 can endure.

The four-bar linkage 61 includes connecting rods 611, 612, connecting disks 613, 614, 615 and joining pivots 616, 617, 618, 619. The four-bar linkage 62 includes connecting rods 621, 622, connecting disks 623, 624, 625 and shafts 626, 627, 628, 629. The shafts 616, 617, 618, 619 pass through the joining holes 6111, 6121, 6112, 6122 at the connecting rods 611, 612. An end of the respective shaft is attached to the connecting disk 613 and the support arm 121 as a fixing end and another end of the respective joining pivot is attached to the connecting disks 614, 615 as a movable end. The shafts 626, 627, 628, 629 pass through the joining holes 6211, 6221, 6212, 6222 at the connecting rods 621, 622. An end of the respective shaft is attached to the connecting disk 623 and the support arm 124 as a fixing end and another end of the respective shaft is attached to the connecting disks 624, 625 as a movable end.

The shaft 51 penetrates the wearable piece 411, the circular through holes 321 of the adjusting member 31, the wearable piece 412, the connecting disk 613, the support arm 121, the sleeve 413 surrounded by the torsion spring 414, the support arm 122, the wearable piece 415 and the disk washer 416 sequentially to engage with the nut 417. The shaft 52 penetrates the wearable piece 421, the circular through holes 322 of the adjusting member 31, the wearable piece 422, the connecting disk 623, the support arm 124, the sleeve 423 surrounded by the torsion spring 424, the support arm 123, the wearable piece 425 and the disk washer 426 sequentially to engage with the nut 427. Further, both ends 4141, 4142 of the torsion spring 414 are inserted into the spring hole 331 of the adjusting member 31 and the spring hole 132 of the support arm 122 respectively. Both ends 4241 (another end not shown) of the torsion spring 424 are inserted into the spring hole 332 of the adjusting member 31 and the spring hole 133 of the support arm 123.

The shafts 51, 52 provide an ellipse cross section to accommodate the restricting pieces with ellipse holes to be joined to the base 120 with the support arms 121, 122, 123, 124 except the adjusting member 31. Hence, the first end 311 and the second end 312 can be movably connected to the base 12 with the actuation parts 41, 42 and are rotated by the actuation parts 41, 42. Magnitudes of the actuation forces exerted by the actuation parts 41, 42 are closely related to the elastic forces of the torsion springs 414, 424 and friction between the connected parts. The angular displacement of the adjusting member 31 is determined by the arc recesses 341, 342 and the locating tongues 131, 134 on the support arms 121, 124. Due to the arc recesses 341, 342 being 60°, the adjusting member 31 is capable of rotating 60° with respect to the base 12.

The shaft 53 penetrates the wearable piece 431, the circular through hole 323 of the adjusting member 31, the wearable piece 432, the connecting disks 614, 615, the wearable piece 433, the circular through hole 1112 of the holding part 111, the two-stage elastic locating piece 434, the wearable piece 435, the two-stage hanging hook 436 and the disk washers 437, 438 sequentially to engage with the nut 439. The shaft 54 penetrates the wearable piece 441, the circular through hole 324 of the adjusting member 31, the wearable piece 442, the connecting disks 624, 625, the wearable piece 443, the circular through hole 1122 of the holding part 112, the two-stage elastic locating piece 444, the wearable piece 445, the two-stage hanging hook 446 and the disk washers 447, 448 sequentially to engage with the nut 449.

Similarly, the shafts 53, 54 provide an ellipse cross section respectively such that the third end 313 and the fourth end 314 of the adjusting member 31 with circular shaft holes can rotationally connect with the actuation parts 43, 44 via the shafts 53, 54 and are restrictively rotated by the actuation parts 43, 44. The magnitudes of the actuation forces exerted by the actuation parts 43, 44 are determined by the friction between the connected parts.

Wherein the holding parts 111, 112 provides locating arc recesses 1111, 1121 for accommodating locating projections 4361, 4461 on the two-stage hanging hooks 436, 446 to limit the screen held by the holding parts 111, 112 to rotate with respect to the adjusting member 31 such that the second stage angular adjustment can be performed properly. Besides, the two-stage hanging hooks 436, 446 provide jut spots 4362, 4462 in association with the locating juts 4341, 4441 on the two-stage elastic locating pieces 434, 444 for limiting rotation of the main monitor member 11 with respect to the adjusting member 31 and performing the first stage angular adjustment.

The locating arc recesses 1111, 1121 are 95° and the locating juts 4341 or the locating juts 4441 space apart 30° from each other. When the main monitor member 11 rotates with respect to the adjusting member 31, the jut spots 4362, 4462 on the two-stage hanging hooks 436, 446 rotate between the locating juts 4341 or between the locating juts 4441 such that the first stage angular adjustment is 30°. Further, when the monitor 10 is folded for storage, a force can be exerted to overcome the resistant forces of the locating juts 4341, 4441 to rotate the main monitor member 11 continuously till the locating projections 4361, 4461 on the two-stage hanging hooks 436, 446 contacting the terminal ends of the locating recesses 1111, 1121. In this way, the second stage angular adjustment can be expanded to 95°.

It is appreciated that in addition to the main monitor member 11 being capable of being adjusted the inclination with respect to the adjusting member 31, i.e., the inclination of the screen, due to the four bar linkages 61, 62 being provided, the adjustable device 30 of the present invention allows the adjusting member 31 being lifted directly without changing inclination of adjusting member 31 during the screen being adjusted height thereof. Therefore, the monitor with the adjustable device 30 according to the present invention not only has strong structure but also is simple to be operated conveniently.

While the invention has been described with referencing to preferred embodiments thereof, it is to be understood that modifications or variations may be easily made without departing from the spirit of this invention, which is defined by the appended claims.

What is claimed is:

1. A monitor with a screen adjustable in highness and inclination comprising:
a base providing a bottom disk and extending upward a first support arm, a second support arm, a third support arm and a fourth support arm from the bottom disk;
a first actuation part;
a first shaft being connected to the first support arm and the second support arm;
a second actuation part;
a third shaft;
a fourth actuation part;
a fourth shaft;
an adjusting member providing a shape of “H” with a first end, a second end, a third end and a fourth end, the first end being actuated by the first actuation part and being rotationally connected to the first shaft, the second end being actuated by the second actuation part and being rotationally connected to the second shaft, the third end being actuated by the third actuation part and being rotationally connected to the third shaft, and the fourth end being actuated by the forth actuation part and being rotationally connected to the fourth shaft;
a first four-bar linkage providing a first fixing end and a first movable end, the first fixing end being connected to the first shaft and the first movable end being connected to the third shaft;
a second four-bar linkage providing a second fixing end and a second movable end, the second fixing end being connected to the second shaft and the second movable end being connected to the fourth shaft; and
a main monitor member providing a display screen, being actuated by the third actuation part to rotationally connect with the third shaft and being actuated by the fourth actuation part to rotationally connect with the fourth shaft.

2. The monitor as defined in claim 1, wherein the first actuation part further comprises:
a first nut engaging the first shaft to the first support arm and the second support arm;
a first sleeve being disposed around the first shaft between the first support arm and the second support arm;
a first torsion spring being disposed to surround the first sleeve, an end thereof being joined to the adjusting member and the another end thereof being joined to the second support arm; and
a plurality of first wearable pieces and first disk washers being penetrated by the first shaft to offer restricting forces to the adjusting member at the time of the adjusting member rotating with respect to the base.

3. The monitor as defined in claim 1, wherein the second actuation part further comprises:
a second nut engaging the second shaft to the third support arm and the fourth support arm;
a second sleeve being disposed around the second shaft between the third support arm and the fourth support arm;
a second torsion spring being disposed to surround the second sleeve, an end thereof being joined to said adjusting member and the another end thereof being joined to the third support arm; and
a plurality of second wearable pieces and second disk washers being penetrated by the second shaft to offer restricting forces to the adjusting member at the time of the adjusting member rotating with respect to the base.

4. The monitor as defined in claim 1, wherein the third actuation part further comprises:
a third nut engaging the third shaft to the third end of the adjusting member and the main monitor member; and
a plurality of third wearable pieces and third disk washers being penetrated by the third shaft to offer restricting forces to the adjusting member at the time of the adjusting member rotating with respect to the base.

5. The monitor as defined in claim 4, wherein the main monitor member has a first holding part with a first locating arc recess and the third actuation part further comprises:
a first two-stage type hanging hook being penetrated by the third shaft, having a first locating projection and at least a first jut spot, said first locating projection being associated with said first locating arc recess to limit the main monitor member rotating a second angular adjustment with respect to the adjusting member; and
a first two-stage type elastic locating piece being penetrated by the third shaft, having a plurality of first locating juts being associated with the first jut spot to limit the main monitor member rotating a first angular adjustment with respect to the adjusting member.

6. The monitor as defined in claim 5, wherein the second angular adjustment is 95° and the first angular adjustment is 30°.

7. The monitor as defined in claim 6, wherein the fourth actuation part further comprises:
a fourth nut engaging the fourth shaft to the fourth end of the adjusting member and the main monitor member; and
a plurality of fourth wearable pieces and fourth disk washers being penetrated by the fourth shaft to offer restricting forces to the adjusting member at the time of the adjusting member rotating with respect to the base.

8. The monitor as defined in claim 7, wherein the main monitor member has a second holding part with a second locating arc recess and the fourth actuation part further comprises:
a second two-stage type hanging hook being penetrated by the fourth shaft, having a second locating projection and at least a second jut spot, said second locating projection being associated with said second locating arc recess to limit the main monitor member rotating the second angular adjustment with respect to the adjusting member; and
a second two-stage type elastic locating piece being penetrated by the fourth shaft, having a plurality of second locating juts being associated with the second jut spot to limit the main monitor member rotating the first angular adjustment with respect to the adjusting member.

9. The monitor as defined in claim 8, wherein the second angular adjustment is 95° and the first angular adjustment is 30°.

10. The monitor as defined in claim 1, wherein the first end and the second end of the adjusting member each have a third locating recess and the first support arm and the second support arm each have a third locating projection corresponding to the third locating recess to limit the main monitor member rotating a third angular adjustment with respect to the base.

11. The monitor as defined in claim 10, wherein the third angular adjustment is 60°.
